(19) United States
(12) Patent Application Publication
(10) Pub. No.: US 2006/0073315 A1
(43) Pub. Date: Apr. 6, 2006

(54) Metallized polyamideimide film for substrate and production method thereof

(75) Inventor: Hiroshi Orikabe, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO., INC, Tokyo (JP)

(21) Appl. No.: 11/239,320

(22) Filed: Sep. 30, 2005

(30) Foreign Application Priority Data
Sep. 30, 2004 (JP) 289113/2004

(51) Int. Cl. B32B 3/00

(52) U.S. Cl. 428/209; 428/325

(57) ABSTRACT

Metallized polyamideimide films for use as a substrate, in which a conductive layer is adhered to a polyamideimide film at high peel strength, may be prepared in a relatively small number of steps without using a special material by treating an inorganic filler-containing polyamideimide film with an alkaline permanganate solution, and subjecting the treated surface to electroless copper plating, or successive electroless copper plating and electrolytic copper plating. Preferably, a potassium permanganate solution or a sodium permanganate solution is used as the alkaline permanganate solution.

### CROSS REFERENCES TO RELATED APPLICATIONS

This application claims priority to Japanese Patent Application No. 2004-289113, filed Sep. 30, 2004, and which is incorporated herein by reference in its entirety.

### BACKGROUND OF THE INVENTION

1. Field of the Invention

The present invention relates to metallized polyamideimide films which are useful as substrates and a production method thereof. More particularly, the present invention relates to metallized polyamideimide films which are particularly useful as a film for tape automated bonding (TAB) or flexible printed circuit (FPC), and a production method thereof.

2. Discussion of the Background

Having superior heat resistance, size stability, solvent resistance and electric mechanical properties, polyimide has been widely used as an insulating material for electronic equipment and the like. For example, CCL (copper clad lamination) comprising a conductive layer formed on a polyimide film has been used for various purposes including flexible printed circuits (FPC) for tape automated bonding (TAB) and the like. In recent years, CCL comprising a conductive layer formed on a polyamideimide film having similar properties as polyimide has also been used.

As CCL, a three-layer CCL poly(amide)imide film in which a polyimide or polyamideimide film and a copper foil are adhered with an adhesive (e.g. epoxy resin and the like) has been generally used. However, the three layer CCL is not optimal because the adhesive to be used exerts an adverse influence on the insulation properties, heat resistance, mechanical strength and the like of CCL, and the inherent characteristics of polyimide or polyamideimide are impaired.

Therefore, a two-layer CCL manufactured without using an adhesive by a method (casting method) comprising coating a copper foil with a polyimide varnish or polyamic acid varnish, and drying the same to form a film is currently prevailing. In this casting method two layer CCL, for example, a copper foil having a thickness of about 12-35 μm is used. With a copper foil having a thickness of not less than 12 μm, formation of a fine circuit pattern at a pitch of less than 40 μm by subtractive methods becomes difficult. Thus, a method comprising reducing the thickness of the conductive layer, by half etching, of a two-layer CCL produced using a 12 μm-thick copper foil, and a method comprising use of a copper foil having a thickness of not more than 5 μm have been employed. In the case of half etching, however, the thickness control is not easy, and when a thin copper foil is used, handling thereof is not easy. Therefore, both methods pose problems of disadvantages in cost.

To solve such problems, for example, a method comprising directly forming a base metal layer (e.g., cobalt, nickel, chrome) on a polyimide film by sputtering, and then forming a conductive layer on the seed layer by electroless copper plating and by electrolytic copper plating to give a two-layer CCL (sputtering method) has been tried. However, the sputtering method is disadvantageous in cost because it requires a special apparatus, and inconveniences such as pinholes and the like easily occur. In addition, the base metal layer is difficult to remove by etching during circuit formation. Furthermore, the sputtering method CCL has problems in heat resistance and its use at high temperature for a long time tends to result in degraded adhesiveness.

On the other hand, a method for forming a conductive layer by plating has been tried without relying on the sputtering method and, for example, the following methods (1)-(8) have been reported.

(1) JP-A-3-6382 discloses a method comprising treating a polyimide film with an aqueous alkaline solution to form a modified layer having a thickness of 100-1500 Å, forming an electrolessly plated metal layer of not more than 1 μm on the modified layer, diffusing the metal within the thickness range of from not less than 50 Å to the thickness of the entire modified layer by heating, and adjusting the thickness of the conductive layer to a desired range by electroless plating and electrolytic plating to give a conductive layer.

(2) JP-A-6-21157 discloses a method comprising making a polyimide film hydrophilic with an aqueous solution of permanganate salt or hypochlorite, forming a nickel plating layer, cobalt plating layer or nickel cobalt plating layer having an impurity content of not more than 10 mass % and a thickness of 0.01-0.1 μby electroless plating, and further forming a conductive layer by electroless copper plating and electrolytic copper plating.

(3) JP-A-8-031881 discloses a method comprising treating a polyimide film with an aqueous solution containing hydrazine and alkali metal hydroxide, adding a catalyst, forming a nickel, cobalt or alloy layer by electroless plating, heat treating the layer under an inert atmosphere, and forming a conductive layer by electroless copper plating and electrolytic copper plating.

(4) JP-A-2000-289167 discloses a method comprising adding a palladium compound to a polyimide precursor, heat treating the same, activating the obtained film with dilute sulfuric acid, and forming a conductive layer by electroless copper plating and electrolytic copper plating.

(5) JP-A-2002-208768 discloses a method comprising treating a polyimide film with an aqueous alkaline solution containing a primary amine-containing organic disulfide compound or a primary amine-containing organic thiol compound, washing and drying the film, adding a catalyst, and forming a conductive layer by electroless copper plating and electrolytic copper plating.

(6) JP-A-2002-256443 discloses a method for forming a conductive layer by subjecting a polyimide film to a swelling treatment, a roughening treatment with an alkaline permanganate solution, a neutralization treatment, a debinding treatment, imide ring opening by alkali treatment, copper ion adsorption by treatment with copper ion solution, copper precipitation by reduction treatment, electroless copper plating and electrolytic copper plating.

(7) JP-A-2003-013243 discloses a method comprising treating a polyimide film with aqueous alkali hydroxide solution, hydrolyzing an imide bond, removing a low molecular hydrolysis product, adding a catalyst, and applying electroless metal plating (when high peel strength is necessary, electroless copper plating needs to be performed after electroless nickel plating).

(8) JP-A-2003-136632 discloses a method comprising manufacturing a polyimide film from alkoxysilane modified polyimide, treating the film with a palladium catalyst solution, and forming a conductive layer by electroless copper plating and electrolytic copper plating.

As a method for forming a conductive layer (copper plating layer) without relying on a dry process, a method comprising, as in the above-mentioned (1), (3), (5) and (7), treating the surface of polyimide with an alkaline solution, and introducing a carboxyl group by ring opening reaction of imide ring to enhance affinity for a metal has been mainly tried. However, (1) is associated with a problem in that each step is difficult to control and lacks versatility, (3) requires nickel or cobalt plating prior to copper plating, (7) also requires nickel plating prior to copper plating so as to afford high peel strength of the conductive layer, and nickel plating and cobalt plating cannot be easily removed by an etching step for circuit formation. Furthermore, (3) and (5) lack versatility and are disadvantageous in cost because they require a special alkaline solution.

In the case of the methods (2) and (6) wherein a polyimide film is treated with an alkaline permanganate solution, the method of (2) requires nickel plating and cobalt plating prior to copper plating, and the method of (6) requires many steps and complicated operation. Thus, all these methods lack versatility and are disadvantageous in cost. In general, moreover, since polyimide films tend to be chemically damaged by alkaline solutions, particularly highly active alkaline permanganate solutions have never been actually used in consideration of the difficulty in controlling the surface during treatments.

With regard to the methods (4) and (8) wherein a conductive layer is formed without treatment with alkaline solution etc., the method of (4) using a polyimide film containing a copper plating catalyst requires use of a considerable amount of an expensive palladium compound, and the method of (8) using alkoxysilane modified polyimide requires use of a special polyimide. Both methods lack versatility and are disadvantageous in cost.

Thus, there remains a need for an efficient and economical production method for providing a metallized polyamideimide film for a substrate wherein a conductive layer having high peel strength is adhered to the polyamideimide film. There also remains a need for a novel metallized polyamideimide film possessing a conductive layer having high peel strength adhered to a polyamidemide film.

### BRIEF SUMMARY OF THE INVENTION

Accordingly, it is one object of the present invention to provide a novel method for producing a metallized polyamidemide film for a substrate, wherein a conductive layer having high peel strength is adhered to the polyamide film, in a relatively small number of steps, without using special material.

It is another object of the present invention to provide a novel metallized polyamidemide film for a substrate which comprises a conductive layer having high peel strength at least on one surface of a polyamide film layer, which is superior in heat resistance, and which can realize a substrate that is superior in insulation properties, heat resistance, and mechanical strength.

These and other objects, which will become apparent during the following detailed description, have been achieved by the inventors' discovery that a roughening treatment with an alkaline permanganate solution on the surface of a polyamide film containing a conventional inorganic filler easily makes the surface of the polyamide film suitable for plating, and copper plating the surface of the polyamide film subjected to the roughening treatment affords a conductive layer (copper plating layer) having high peel strength.

Accordingly, the present invention provides the following:

(1) A method of producing a metallized polyamideimide film for a substrate, which comprises treating an inorganic filler-containing polyamideimide film with an alkaline permanganate solution, and subjecting the film to electroless copper plating.

(2) The method of (1), wherein the inorganic filler-containing polyamideimide film is obtained by drying by heating a resin composition varnish comprising a polyamideimide and inorganic filler.

(3) The method of (2), wherein the resin composition varnish is applied onto a support, and the treatment with an alkaline permanganate solution and the electroless copper plating are successively performed.

(4) The method of (3), wherein the support is a copper foil.

(5) The method of (3), wherein the support is a polyimide film.

(6) The method of any of (1)-(5), wherein the inorganic filler-containing polyamideimide film is subjected to a swelling treatment with an alkaline solution before the treatment with an alkaline permanganate solution.

(7) The method of any of (1)-(6), wherein electrolytic copper plating is further applied after the electroless copper plating.

(8) The method of any of (1)-(7), wherein a catalyst is provided onto the surface of the inorganic filler-containing polyamideimide film before the electroless copper plating.

(9) The method of (8), wherein the catalyst is palladium.

(10) The method of any of (1)-(9), wherein the inorganic filler is one or more kinds selected from the group consisting of silica, silicon particles, and calcium carbonate.

(11) The method of any of (1)-(9), wherein the inorganic filler is silica.

(12) The method of any of (1)-(11), wherein the inorganic filler has an average particle size of 0.01-5 μm.

(13) The method of any of (1)-(12), wherein the inorganic filler is contained in the varnish in a proportion of 2-100 parts by weight per 100 parts by weight of polyamideimide.

(14) The method of any of (1)-(13), wherein the alkaline permanganate solution is a potassium permanganate solution or a sodium permanganate solution.

(15) The method of any of (1)-(6), (8)-(14), wherein the inorganic filler-containing polyamideimide film has a thickness of 5-125 μm, and the electroless copper plating layer has a thickness of 0.1-3 μm.

(16) The method of any of (7)-(14), wherein the inorganic filler-containing polyamideimide film has a thickness of 5-125 μm, the electroless copper plating layer has a thickness of 0.1-3 μm, and the total thickness of the electroless copper plating layer and the electrolytic copper plating layer is 3-35 μm.

(17) The method of any of (4), (6)-(16), wherein the copper foil support has a thickness of 3-35 μm.

(18) The method of any of (5)-(16), wherein the polyimide film support has a thickness of 10-125 μm.

(19) The method of any of (1)-(18), wherein an annealing treatment is conducted after the electroless copper plating or the electrolytic copper plating.

(20) The method of any of (1)-(19), wherein the inorganic filler-containing polyamideimide film further comprises one or more kinds of heat resistant resins selected from the group consisting of polyamide, polyimide, polyetheretherketone, polyetherimide, polybenzoxazole, and polybenzoimidazole in a proportion of not more than 30 parts by weight relative to 100 parts by weight of polyamideimide.

(21) The method of (20), wherein the heat resistant resin has a phenolic hydroxyl group in a molecular skeleton.

(22) A metallized polyamideimide film comprising a polyamideimide film layer and a conductive layer formed on at least one surface of the polyamideimide film layer, wherein the polyamideimide film layer comprises an inorganic filler and has a roughening treated surface on which the conductive layer is formed.

(23) The metallized polyamideimide film of (22), wherein the polyamideimide film layer containing an inorganic filler is formed on a support.

(24) The metallized polyamideimide film of (23), wherein the support is a copper foil layer.

(25) The metallized polyamideimide film of (23), wherein the support is a polyimide film layer.

(26) The metallized polyamideimide film of any of (22)-(25), wherein the inorganic filler is one or more kinds selected from the group consisting of silica, silicon particles and calcium carbonate.

(27) The metallized polyamideimide film of any of (22)-(25), wherein the inorganic filler is silica.

(28) The metallized polyamideimide film of any of (22)-(27), wherein the inorganic filler has an average particle size of 0.01-5 μm.

(29) The metallized polyamideimide film of any of (22)-(28), wherein the polyamideimide film layer has an inorganic filler content of 2-100 mass % relative to polyamideimide.

(30) The metallized polyamideimide film of any of (22), (26)-(29), wherein the polyamideimide film layer has a thickness of 5-125 μm, and the conductive layer has a thickness of 3-35 μm.

(31) The metallized polyamideimide film of any of (24), (26)-(29), which comprises a laminate of the copper foil layer/the polyamideimide film layer comprising an inorganic filler/the conductive layer laminated in this order, wherein the copper foil layer has a thickness of 3-35 μm, the polyamideimide film layer has a thickness of 5-125 μm, and the conductive layer has a thickness of 3-35 μm.

(32) The metallized polyamideimide film of any of (25)-(29), which comprises a laminate of the polyimide film layer/the polyamideimide film layer comprising an inorganic filler/the conductive layer laminated in this order, wherein the polyimide film layer has a thickness of 10-125 μm, the polyamideimide film layer has a thickness of 5-125 μm, and the conductive layer has a thickness of 3-35 μm.

(33) The metallized polyamideimide film of any of (22)-(32), wherein the roughening treated surface of the polyamideimide film layer has a surface roughness of 100-1500 nm.

(34) The metallized polyamideimide film of any of (22)-(33), wherein the conductive layer is a copper plating layer.

(35) The metallized polyamideimide film of any of (22)-(34), wherein the roughening treatment of the roughening treated surface of the polyamideimide film layer is a treatment with an alkaline permanganate solution.

(36) The metallized polyamideimide film of (35), wherein the alkaline permanganate solution is a potassium permanganate solution or a sodium permanganate solution.

(37) The metallized polyamideimide film of any of (22)-(36), wherein the inorganic filler-containing polyamideimide film further comprises one or more kinds of heat resistant resins selected from the group consisting of polyamide, polyimide, polyetheretherketone, polyetherimide, polybenzoxazole and polybenzoimidazole in a proportion of not more than 30 parts by weight relative to 100 parts by weight of polyamideimide.

(38) The metallized polyamideimide film of (37), wherein the heat resistant resin has a phenolic hydroxyl group in a molecular skeleton.

According to the method of producing a metallized polyamideimide film of the present invention, a metallized polyamideimide film comprising a conductive layer having high peel strength adhered to the polyamideimide film, which is particularly preferable for a substrate, can be produced in a relatively small number of steps without using a special material. According to the present invention, the production efficiency can be improved and the production costs can be reduced, as compared to conventional production methods of this kind of metallized polyamideimide films.

Using a metallized polyamideimide film of the present invention, moreover, a material for a substrate, which is superior in heat resistance and which does not require complicated steps for circuit formation, can be provided, since the film has a conductive layer having high peel strength, which is formed on at least one surface thereof, and is free of an adhesive and a seed layer between the conductive layer and the polyamideimide film layer. Consequently, manufacture of a substrate superior in insulation properties, heat resistance, mechanical strength, and the like at a low cost can be enabled using a metallized polyamideimide film of the present invention.

### DETAILED DESCRIPTION OF THE PREFERRED EMBODIMENTS

The production method of the metallized polyamideimide film of the present invention is mainly characterized in that a polyamideimide film comprising an inorganic filler is treated with an alkaline permanganate solution and then subjected to electroless copper plating.

That is, the present invention is predicated on the finding that, by subjecting a polyamideimide film containing polyamideimide and an inorganic filler (hereinafter to be also referred to as “inorganic filler-containing polyamideimide film”), which is formed using a resin composition varnish containing an inorganic filler, to a treatment with an alkaline permanganate solution, the surface of the polyamideimide film comes to have a rough surface preferable for electroless copper plating, and by subjecting the roughening treated surface of the polyamideimide film to electroless copper plating, a conductive layer made of a copper plating layer having high peel strength can be formed. Preferably, by conducting electrolytic copper plating after electroless copper plating, a conductive layer made of a copper plating layer having higher peel strength can be formed. Moreover, since the polyamideimide film contains an inorganic filler, the surface can be easily controlled even when the surface of the polyamideimide film is treated with an alkaline permanganate solution, which facilitates formation of a rough surface preferable for forming a conductive layer by plating.

In the production method of a metallized polyamideimide film of the present invention, use of a special material is not necessary, and a metallized polyamideimide film, which comprises a laminate comprising a polyamideimide film layer, wherein at least one surface is roughening treated, and a conductive layer made of a copper plating layer, which is adhered at high peel strength to the roughening treated surface(s) of the polyamideimide film layer, can be obtained in a relatively small number of steps. In addition, the thus-obtained metallized polyamideimide film does not require an adhesive and a seed layer formed by sputtering or plating for the formation of a copper plating layer. Therefore, it can be used as a material for a substrate, which is superior in heat resistance, and which does not require complicated steps for circuit formation. Using the metallized polyamideimide film, a substrate superior in insulation properties, heat resistance, mechanical strength, and the like can be manufactured at a low cost.

A resin composition varnish containing polyamideimide and an inorganic filler to be used in the present invention (hereinafter to be also referred to as an “inorganic filler-containing resin composition varnish”) is made of a polyamideimide varnish used for producing a polyamideimide film by casting method and the like and an inorganic filler, and as the polyamideimide varnish, known ones can be used without any limitation, as long as the film forming is possible.

The polyamideimide in the polyamideimide varnish is a polymer having an amide bond and an imide bond in a molecule. The polyamideimide can be obtained by reacting an acid component and a diamine component in a high boiling point polar solvent according to known polyamideimide synthetic methods such as the acid chloride method, the isocyanate method, and the like. As used herein, by the “acid component” is meant tricarboxylic acid and acid anhydride thereof, tetracarboxylic acid and acid anhydride thereof, dicarboxylic acid, diimidedicarboxylic acid, and these compounds having acid chloride instead of carboxylic acid. The “diamine component” means a diamine compound or a diisocyanate compound in the case of isocyanate methods.

As methods of making the polyamideimide, (1) a method comprising reacting a tricarboxylic acid anhydride and a diisocyanate compound, (2) a method comprising reacting an acid chloride of tricarboxylic acid anhydride and a diamine compound, (3) a method comprising reacting a tetracarboxylic acid anhydride, a dicarboxylic acid compound and a diamine compound, and (4) a method comprising reacting adiimidedicarboxylic acid and a diisocyanate compound, and the like can be mentioned.

As the tricarboxylic acid anhydride when reacting the tricarboxylic acid anhydride and a diisocyanate compound in (1), for example, trimellitic anhydride, butane-1,2,4-tricarboxylic acid anhydride, naphthalene-1,2,4-tricarboxylic acid anhydride, and the like can be mentioned, with preference given to trimellitic anhydride. These may be used alone or two or more of them are used in combination. As the diisocyanate compound, for example, alicyclic diisocyanates such as 1,4-cyclohexanediisocyanate, 1,3-cyclohexanediisocyanate, isophoronediisocyanate, dicyclohexylmethane-4,4′-diisocyanate, and the like; aromatic diisocyanates such as m-phenylenediisocyanate, p-phenylenediisocyanate, diphenylmethane-4,4′-diisocyanate, diphenylether-4,4′-diisocyanate, diphenylsulfone-4,4′-diisocyanate, (1,1′-biphenyl)-4,4′-diisocyanate, (1,1′-biphenyl)-3,3′-dimethyl-4,4′-diisocyanate, 2,4-tolylenediisocyanate, 2,6-tolylenediisocyanate, xylenediisocyanate, 1,4-naphthalenediisocyanate, 1,5-naphthalenediisocyanate, 2,6-naphthalenediisocyanate, 2,7-naphthalenediisocyanate, and the like; and the like can be mentioned, with preference given to aromatic diisocyanate. These may be used alone or two or more of them are used in combination.

As the acid chloride of the tricarboxylic acid anhydride when reacting the acid chloride of tricarboxylic acid anhydride and a diamine compound in (2), for example, trimellitic anhydride chloride, acid chloride of butane-1,2,4-tricarboxylic anhydride, acid chloride of naphthalene-1,2,4-tricarboxylic anhydride, and the like can be mentioned, with preference given to trimellitic anhydride chloride. These may be used alone or two or more of them are used in combination. As the diamine compound, for example, aliphatic diamines such as ethylenediamine, propylenediamine, hexamethylenediamine, and the like; alicyclic diamines such as 1,4-cyclohexanediamine, 1,3-cyclohexanediamine, isophoronediamine, 4,4′-diamino dicyclohexylmethane, and the like; aromatic diamines such as m-phenylenediamine, p-phenylenediamine, 4,4′-diaminodiphenylmethane, 4,4′-diaminodiphenylether, 4,4′-diaminodiphenylsulfone, benzidine, o-tolidine, 2,4-tolylenediamine, 2,6-tolylenediamine, xylylenediamine, 1,4-naphthalenediamine, 1,5-naphthalenediamine, 2,6-naphthalenediamine, 2,7-naphthalenediamine, and the like; can be mentioned, with preference given to aromatic diamine. These may be used alone or two or more of them can be used in combination.

As the tetracarboxylic acid anhydride when reacting tetracarboxylic acid anhydride, a dicarboxylic acid compound and a diamine compound in (3), for example, pyromellitic anhydride, biphenyltetracarboxylic acid anhydride, biphenylsulfonetetracarboxylic acid anhydride, benzophenonetetracarboxylic acid anhydride, biphenylethertetracarboxylic acid anhydride, ethylene glycol bistrimellitic anhydride, propylene glycol bistrimellitic anhydride, and the like can be mentioned, with preference given to pyromellitic anhydride and biphenyltetracarboxylic acid anhydride. These may be used alone or two or more of them can be used in combination. As the dicarboxylic acid compound, moreover, for example, aliphatic dicarboxylic acids such as oxalic acid, adipic acid, malonic acid, sebacic acid, azelaic acid, dodecanedicarboxylic acid, dicarboxypolybutadiene, dicarboxypoly(acrylonitrile-butadiene), dicarboxypoly(styrene-butadiene) and the like; alicyclic dicarboxylic acids such as 1,4-cyclohexanedicarboxylic acid, 1,3-cyclohexanedicarboxylic acid, 4,4′-dicyclohexylmethanedicarboxylic acid, dimer acid and the like; aromatic dicarboxylic acids such as terephthalic acid, isophthalic acid, diphenylsulfonedicarboxylic acid, diphenyl ether dicarboxylic acid, naphthalenedicarboxylic acid and the like, and the like can be mentioned. These may be used alone or two or more of them can be used in combination. As the diamine compound, moreover, those exemplified above can be mentioned, which may be used alone or two or more of them can be used in combination.

As the diimidedicarboxylic acid when reacting diimidedicarboxylic acid and a diisocyanate compound in (4), for example, diimidedicarboxylic acid that can be obtained by reacting tricarboxylic acid anhydride and a diamine compound at a ratio of about 2:1 can be mentioned. As the tricarboxylic acid anhydride and diamine compound here, those exemplified above can be mentioned. As the diisocyanate compound, too, those exemplified above can be mentioned.

For controlling the properties of polyamideimide, two or more from the above-mentioned methods (1)-(4) may be combined to carry out synthesis reactions (polymerization reaction) in multi-steps.

As a high melting point polar reaction solvent, N,N-dimethylacetamide, N-methyl-2-pyrrolidone, N,N-dimethylformamide, γ-butyrolactone and the like can be mentioned. The reaction temperature is generally about 60-200° C. The reaction solutions obtained by the above-mentioned methods (1), (3), (4) can be used as they are or, after substituting the solvent as necessary, without particular purification for as polyamideimide varnish. In the method of the above-mentioned (2), since removal of chlorine ion etc., becomes necessary, the reaction solution is desirably poured into a solvent (coagulation bath), which is a poor solvent to polyamideimide and miscible with a high boiling point polar solvent, thereby separating the polyamide from the reaction solvent (high boiling point polar solvent), after which the polyamide is washed with water, acetone and the like, and dried to give a solid. By re-dissolving the obtained polyamideimide (solid) in a solvent, the polyamideimide varnish is obtained. While the solvent can be appropriately selected from the solvents in which polyamideimide can be dissolved, for example, high boiling point solvents such as N,N-dimethylacetamide, N-methyl-2-pyrrolidone, N,N-dimethylformamide, γ-butyrolactone, and the like; alcohols such as methanol, ethanol, butanol, and the like; aromatic hydrocarbons such as toluene, xylene, and the like; ethers such as tetrahydrofuran, dioxane, and the like; and ketones such as cyclopentanone, cyclohexanone, and the like; and a mixed solvent; and the like can be mentioned. In the above-mentioned methods (1), (3), (4), such purification may be conducted where necessary.

The polyamideimide may be used alone or two or more thereof may be used in a mixture.

As the polyamideimide varnish to be used in the present invention, which affords film formation, a commercially product can be used as it is. Specific examples of polyamideimide varnish include Vylomax HR11NN, Vylomax HR16NN (product of Toyobo Co., Ltd.), KS6000 (product of Hitachi Chemical Co., Ltd.) and the like. In addition, for example, polyamideimide such as Torlon AI-10 (product of Solvay Advanced Polymers K.K.) and the like may be dissolved in an organic solvent to give a varnish.

The metallized polyamideimide film of the present invention is intended for use as a substrate (particularly flexible printed circuit (FPC)) and a polyamideimide varnish having a suitable structure and properties can be appropriately selected according to the properties requested for a substrate, such as heat resistance, mechanical strength and the like. A polyamideimide varnish having an aromatic ring structure is generally preferable.

In the present invention, an inorganic filler-containing resin composition varnish can be prepared by mixing and dispersing an inorganic filler with/in the above-mentioned polyamideimide varnish. Alternatively, an inorganic filler may be dispersed in a solvent capable of dissolving the aforementioned polyamideimide to give a slurry, and polyamideimide may be dissolved in this slurry. This inorganic filler-containing resin composition varnish may contain a slight amount of a heat resistant resin other than polyamideimide, and as other heat resistant resins, for example, polyamide, polyimide, polyetheretherketone, polyetherimide, polybenzoxazole, polybenzoimidazole and the like can be mentioned, with preference given to polyamide. Two or more heat resistant resins may be mixed and used. The presence of a suitable amount of other heat resistant resin produces a phase separation structure, and when a polyamideimide film is roughening treated, small roughness is easily formed. An inorganic filler-containing resin composition varnish containing such heat resistant resin can be prepared by dissolving a heat resistant resin in a solvent capable of dissolving the aforementioned polyamideimide to give a solution, mixing the solution (varnish) and polyamideimide varnish, and mixing or dispersing an inorganic filler. To improve affinity for a metal layer or a polyamideimide film to be a support, a heat resistant resin preferably has a phenolic hydroxyl group in the molecular skeleton, and one having a phenolic hydroxyl group equivalent amount in the range of 100-1500 g/eq is particularly preferable. The amount of the heat resistant resin to be added is not more than 30 parts by weight, preferably 0.5-30 parts by weight, more preferably 5-30 parts by weight, relative to 100 parts by weight of polyamideimide. When it exceeds 30 parts by weight, the phase separation tends to be too great.

The mixing•dispersion for the preparation of the inorganic filler-containing resin composition varnish can be conducted using a homogenizer, a rotating•revolving mixer, a 3-roll mill, a ball mill and the like, with preference given to a homogenizer and a rotating•revolving mixer. When a roll mill such as a 3-roll mill and the like is used, the resin composition varnish tends to absorb moisture, and when the moisture absorption is remarkable, the resin is often precipitated on the roll. When the above-mentioned heat resistant resin is added, which can be added optionally, one free of precipitation and decrease in the molecular weight, which are caused by moisture absorption, and the like is selected. Using a roll mill, an inorganic filler is dispersed in advance in the heat resistant resin, and the resin is mixed with polyamideimide varnish, whereby mixing-dispersion can be conducted well. In addition, an inorganic filler may be dispersed in advance in the aforementioned solvent to give a slurry, which slurry is then mixed with polyamideimide varnish.

It is also possible to carry out the above-mentioned polycondensation reaction in the slurry to prepare the polyamideimide varnish.

In the present invention, as the inorganic filler, those generally used as fillers (e.g., various plastic formed parts, etc) can be used and, for example, silica, alumina, barium sulfate, talc, clay, mica powder, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate, silicon particles, and the like can be mentioned. Of these, silica, silicon particles, and calcium carbonate are preferable for achieving superior plating peel strength and the like, and silica is particularly preferable. These inorganic fillers may be surface treated with a surface treatment agent (e.g., silane coupling agent etc.) for the purpose of improving the moisture resistance of a metallized polyamideimide film (substrate) to be produced. The inorganic filler may be used alone or two or more kinds thereof may be used in a mixture.

The inorganic filler to be used in the present invention preferably has an average particle size of 0.01-5 μm, more preferably 0.05-2 μm. When the average particle size exceeds 5 μm, a fine pattern may not be formed stably when forming a circuit pattern from a conductive layer formed by plating after a roughening treatment. When the average particle size is less than 0.01 μm, the roughened surface may not be sufficiently formed by a roughening treatment, which may unpreferably result in a failure to provide sufficient plating peel strength. The inorganic filler preferably has a maximum particle size of not more than 10 μm, more preferably not more than 5 μm, and further preferably not more than 3 μm. For controlling the maximum particle size of an inorganic filler, air classification comprising blowing air to an inorganic filler and classifying the inorganic filler based on mass differences, filtration classification comprising dispersing an inorganic filler in water and classifying the inorganic filler by filtration and the like can be mentioned. The amount of the inorganic filler to be added is preferably 2-100 parts by weight, more preferably 5-45 parts by weight, relative to 100 parts by weight of polyamideimide (solid content) in varnish (when a heat resistant copolymer resin is contained, relative to the total amount (solid content) of polyamideimide and heat resistant copolymer resin). When it exceeds 100 parts by weight, degradation of the resin surface becomes remarkable during a roughening treatment and sufficient plating peel strength tends to be difficult to achieve. When it is less than 2 parts by weight, a roughened surface is not sufficiently formed by a roughening treatment and sufficient plating peel strength tends to be difficult to achieve.

The above-mentioned average particle size of the inorganic filler can be measured by laser diffraction•scattering methods based on Mie scattering. To be specific, the particle size distribution of an inorganic filler is plotted based on volume by a laser diffraction type particle size distribution measurement device, and the median diameter can be taken as the average particle size. As a measurement sample, an inorganic filler can be dispersed in water by ultrasonication and preferably used as the sample. As the laser diffraction type particle size distribution measurement device, LA-500 manufactured by HORIBA Ltd. and the like can be used.

Where necessary, the polyamideimide varnish to be used in the present invention may contain components other than those mentioned above, as long as properties that a polyamideimide film is required to have for use as a flexible printed circuit, and the effect of the present invention are not impaired. For example, coupling agents, coloring agents, thixotropic agents, antistatic agents, plasticizers, and the like can be mentioned. In general, thermosetting resins such as epoxy resin and the like often fail to have heat resistance necessary for polyamideimide film production, and tend to increase dimensional changes of polyamideimide film. Thus, it is preferable that thermosetting resins be substantially absent from the polyamideimide film varnish to be used in the present invention.

In the present invention, an inorganic filler-containing polyamideimide film is generally formed by applying a resin composition varnish containing the above-mentioned polyamideimide and an inorganic filler onto a support, and drying the film by heating. While the thickness of the inorganic filler-containing polyamideimide film thus formed varies depending on the lamination structure of the object substrate, specific use and the like, it is generally about 5-125 μm. When it is less than 5 μm, the mechanical strength of an insulating layer of the substrate may become insufficient, and when it exceeds 125 μm, the cost becomes high and coating and drying of the varnish tends to be difficult. Then, the inorganic filter-containing polyamideimide film thus formed is treated with an alkaline permanganate solution and copper plating is applied to the surface roughening treated by the alkaline permanganate solution.

As the above-mentioned support, any can be used as long as it is made from a material substantially free from causing property and morphology changes during preparation of an inorganic filler-containing polyamideimide film by coating with a resin composition varnish containing the above-mentioned polyamideimide and an inorganic filler, and drying the film by heating. When the final product (metallized polyamideimide film) is a structure comprising an inorganic filler-containing polyamideimide film layer laminated on a support, heat resistant films such as polyimide film, aramid film and the like (preferably polyimide film), metal foils such as copper foil, aluminum foil, stainless foil and the like (preferably copper foil) and the like are generally used as the support. In the present invention, therefore, whether the support is to be delaminated in advance from an inorganic filler-containing polyamideimide film before a treatment with an alkaline permanganate solution (when the metallized polyamideimide film to be produced is a laminate structure without a support) or to be laminated on an inorganic filler-containing polyamideimide film (when the metallized polyamideimide film to be produced is a laminate structure having a support) is determined depending on the lamination structure of the produced metallized polyamideimide film. When a copper,foil is used as a support, the thickness of the copper foil is preferably about 3-35 μm, more preferably about 12-35 μm. When the thickness is less than 3 μm, the workability during coating and drying of varnish and the like is degraded, and when the thickness exceeds 35 μm, formation of a fine circuit pattern from the copper foil tends to become difficult. In other words, when a copper foil is used as a conductive layer in the final product (metallized polyamideimide film for a substrate), a fine circuit pattern cannot be formed easily from the conductive layer. When a polyimide film is used as a support, the thickness of the polyimide film is preferably about 10-125 μm, more preferably about 25-75 μm. When the thickness is less than 10 μm, the supportability during coating and drying of varnish becomes inferior, and when it exceeds 125 μm, the bending property of the final product (metallized polyamideimide film) is degraded. The polyimide film is used as an insulating layer in the final product (metallized polyamideimide film for a substrate).

The lamination structure of the metallized polyamideimide film of the present invention (final product) is as mentioned below.

The drying by heating of an inorganic filler-containing resin composition varnish is divided into an initial heating step for volatilization of solvent to form a film, and middle—last heating steps for complete removal of the solvent. For example, the initial heating step can be appropriately determined according to the workability while considering difference in the boiling points of solvents, adhesiveness between the support and the resin composition and the like. Generally, it can be appropriately selected from the range of about 1 minute-30 minutes at 75-150° C. In addition, preferable conditions of the middle—last heating steps can be appropriately determined by those of ordinary skill in the art and selected from the range of, for example, 160-370° C. for 1-40 hours. The middle—last heating steps may be one-step heating comprising heating at a constant temperature for a given time. Multi-step heating such as three-step heating comprising heating within a low temperature range (constant temperature selected from the range of 160-220° C.) for about 5 minutes-12 hours and then within a middle temperature range (constant temperature selected from the range of 220-300° C.) for about 30-18 hours and then further within a high temperature range (constant temperature selected from the range of 300-370° C.) for about 1-24 hours, and the like is preferably conducted for the purpose of preventing the warp of an inorganic filler-containing polyamideimide film.

In the present invention, as the alkaline permanganate solution to be used for a roughening treatment of the surface of an inorganic filler-containing polyamideimide film, for example, a solution obtained by dissolving potassium permanganate or sodium permanganate in an aqueous sodium hydroxide solution can be mentioned. The treatment method using an alkaline permanganate solution is not particularly limited and may be performed by, for example, immersing an inorganic filler-containing polyamideimide film delaminated from a support in an alkaline permanganate solution heated to 40-80° C., immersing an inorganic filler-containing polyamideimide film formed on a support in an alkaline permanganate solution heated to 40-80° C., together with the support and the like. While the treatment time is not particularly limited, about 5-20 minutes is preferable. The concentration of the permanganate salt in an alkaline permanganate solution is preferably about 80-150 μg/l, more preferably about 110-120 μg/l.

It is preferable to conduct a treatment to swell a polyamideimide film prior to a treatment with an alkaline permanganate solution. For the swelling treatment, an alkaline solution, a surfactant solution and the like can be used, with preference given to an alkaline solution. As the alkaline solution, for example, sodium hydroxide solution, potassium hydroxide solution and the like can be mentioned. In addition, a commercially available swelling solution may be used and, for example, produced by Atotech Japan, Swelling Dip Securiganth P and Swelling Dip Securiganth SBU and the like can be mentioned. The method of the swelling treatment is not particularly limited and may be performed by, for example, immersing an inorganic filler-containing polyamideimide film delaminated from a support in a swelling solution heated to 40-80° C., immersing an inorganic filler-containing polyamideimide film formed on a support in a swelling solution heated to 40-80° C., together with the support and the like. While the treatment time is not particularly limited, about 5-20 minutes is preferable.

The level of the roughening treatment of the surface of a polyamideimide film to be roughening treated in this way (surface roughness) is defined by the arithmetic average roughness (Ra) described in the Japan Industrial Standard (JIS) B0601. Specifically, for example, it can be measured using a surface shape measurement system WYCO NT3300 manufactured by Veeco Instruments. The surface roughness (arithmetic average roughness (Ra)) is preferably 100-1500 nm, more preferably 100-1200 nm, and further preferably 200-800 nm. When it is less than 100 nm, sufficient plating peel strength tends to be unavailable, and when it exceeds 1500 nm, formation of a fine circuit pattern tends to become unpreferably difficult.

A copper plating layer on a roughening treated surface of an inorganic filler-containing polyamideimide film, or formation of a conductive layer by copper plating, can be performed by a method combining electroless copper plating and electrolytic copper plating, or a method comprising forming a plating resist of a pattern reverse to the pattern of the conductive layer and forming the conductive layer by electroless copper plating alone.

The electroless copper plating can be conducted according to the methods generally used for additive method or semi-additive method of printed wiring board. That is, a catalyst is provided to the surface of an inorganic filler-containing polyamideimide film which has been roughened by the aforementioned treatment with an alkaline permanganate solution, and immersed in a given electroless copper plating solution under given conditions. As the catalyst to be provided for the roughening treatment of a surface, palladium metals widely used for electroless copper plating are preferable. While various electroless copper plating solutions having different plating components (e.g., chelating agents, reducing agents etc.) are commercially available, the solution is not particularly limited.

Plating of the surface of a electroless copper plating by electrolytic copper can be conducted according to a known method. As the electrolytic copper plating solution, various solutions having different plating components can be used. Particularly, generally used sulfuric acid copper plating bath is preferable.

The thickness of the electroless copper plating layer is generally 0.1-3 μm, preferably 0.3-2 μm. The thickness of the electrolytic copper plating layer is such thickness that makes the total thickness with the electroless copper plating layer to be 3-35 μm, preferably 5-20 μm. To be specific, a electroless copper plating layer having a thickness of 0.1-3 μm (preferably 0.3-2 μm) is formed, and an electrolytic copper plating layer is formed such that the total thickness of the electroless copper plating layer and the electrolytic copper plating layer becomes 3-35 μm (preferably 5-20 μm).

The thus-obtained conductive layer made of a copper plating layer is formed with high peel strength on the roughening treated surface of an inorganic filler-containing polyamideimide film. After electroless copper plating, or after successively conducting electroless copper plating and electrolytic copper plating, an annealing treatment is applied at 150-200° C. for about 30 minutes-100 hours, whereby peel strength of the conductive layer from the inorganic filler-containing polyamideimide film can be further improved and stabilized.

With such an annealing treatment, the peel strength of the conductive layer made of a copper plating layer from the inorganic filler-containing polyamideimide film of the metallized polyamideimide film of the present invention can be, for example, not less than 0.5 kgf/cm, preferably not less than 0.7 kgf/cm, as measured by the following measurement method.

Measurement Method of Peel Strength.

The measurement was performed according to JIS C6481. The thickness of the conductive plating of the measurement sample was about 30 μm.

The metallized polyamideimide film of the present invention is used for substrates and finally manufactured into, for example, the following laminates (1)-(5).

(1) conductive layer (copper plating layer)/inorganic filler-containing polyamideimide film layer;

(2) copper foil layer (support)/inorganic filler-containing polyamideimide film layer/conductive layer (copper plating layer);

(3) conductive layer (copper plating layer)/inorganic filler-containing polyamideimide film layer/conductive layer (copper plating layer);

(4) polyimide film layer (support)inorganic filler-containing polyamideimide film layer/conductive layer (copper plating layer);

(5) conductive layer (copper plating layer)/inorganic filler-containing polyamideimide film layer/polyimide film layer (support)/inorganic filler-containing polyamideimide film layer/conductive layer (copper plating layer).

The laminate (1) is manufactured by forming an inorganic filler-containing polyamideimide film on a support, successively applying an alkaline permanganate solution treatment and a electroless copper plating treatment to form a electroless copper plating layer and then delaminating the support from the inorganic filler-containing polyamideimide film; or forming a electroless copper plating layer, further forming an electrolytic copper plating layer and then delaminating a support from an inorganic filler-containing polyamideimide film.

When the laminate (1) is particularly used for a flexible printed circuit (FPC), the thickness of the inorganic filler-containing polyamideimide film layer is preferably about 10-75 μm.

The laminate (2) is manufactured by forming an inorganic filler-containing polyamideimide film on a copper foil, and successively applying an alkaline permanganate solution treatment and a electroless copper plating treatment to form a electroless copper plating layer; or forming a electroless copper plating layer, and further forming an electrolytic copper plating layer.

When the laminate (2) is particularly used for a flexible printed circuit (FPC), the thickness of the inorganic filler-containing polyamideimide film layer is preferably about 5-75 μm, particularly preferably about 10-50 μm.

The laminate (3) is manufactured by forming an inorganic filler-containing polyamideimide film on a support, delaminating the support and successively applying an alkaline permanganate solution treatment and a electroless copper plating treatment to both surfaces of the inorganic filler-containing polyamideimide film to form electroless copper plating layers; or forming a electroless copper plating layer, and further forming an electrolytic copper plating layer.

When the laminate (3) is particularly used for a flexible printed circuit (FPC), the thickness of the inorganic filler-containing polyamideimide film layer is preferably about 10-75 μm.

The laminate (4) is manufactured by forming an inorganic filler-containing polyamideimide film on one surface of a polyimide film (support), and successively applying an alkaline permanganate solution treatment and a electroless copper plating treatment to the inorganic filler-containing polyamideimide film to form electroless copper plating layers; or forming a electroless copper plating layer, and further forming an electrolytic copper plating layer.

When the laminate (4) is particularly used for a flexible printed circuit (FPC), the thickness of the polyimide film (support) is preferably about 10-75 μm, and the thickness of the inorganic filler-containing polyamideimide film layer is preferably about 10-75 μm, particularly preferably about 10-25 μm.

The laminate (5) is manufactured by forming an inorganic filler-containing polyamideimide film on both surfaces of a polyimide film (support), and successively applying an alkaline permanganate solution treatment and a electroless copper plating treatment to both surfaces of the inorganic filler-containing polyamideimide film to form electroless copper plating layers; or forming electroless copper plating layers, and further forming electrolytic copper plating layers.

When the laminate (5) is particularly used for a flexible printed circuit (FPC), the thickness of the polyimide film (support) is preferably about 10-50 μm, and the thickness of the inorganic filler-containing polyamideimide film layer is particularly preferably about 10-25 μm.

When a substrate is to be manufactured using a metallized polyamideimide film of the present invention, a circuit can be formed from a conductive layer (copper plating layer) by subtractive methods and semi-additive methods known to the skilled artisan in the technical field of substrates, and the like. In the case of subtractive methods, an electrolytic plating layer is formed on a electroless copper plating layer, an etching resist is formed thereon and the copper plating layers are etched with an etching solution of ferric chloride, copper (II) chloride etc. to form a conductor pattern, after which the etching resist is removed to give a circuit. In the case of semi-additive methods, a pattern resist is applied on a electroless copper plating layer, an electrolytic copper plating layer (pattern plating layer) having a desired thickness is formed, the pattern resist is removed and the electroless copper plating layer is removed by flash etching to give a substrate.

A circuit can be formed from a copper foil by, for example, forming an etching resist on the copper foil, and etching the copper foil with an etching solution of ferric chloride, copper (II) chloride etc. to give a conductor pattern, and removing the etching resist.

Other features of the invention will become apparent in the course of the following descriptions of exemplary embodiments which are given for illustration of the invention and are not intended to be limiting thereof.

### EXAMPLES

In the following examples, “parts” means “parts by mass.”

### Example 1

Polyamideimide varnish “Vylomax HR16NN” (70 parts, solid content 14 w %, manufactured by Toyobo Co., Ltd.) was mixed with silica particles (2.5 parts, average particle size: 0.22 μm), and the mixture was dispersed in a rotating•revolving mixer (AwatoriRentaro AR250, manufactured by Thinky corporation) for 12 minutes to give a resin composition varnish (a).

Then, this resin composition varnish (a) was applied to a mat surface of a 18 μm-thick copper foil with a bar coater such that the resin thickness after drying became 30 μm, and stepwisely dried at 75-130° C. (average 110° C.) for about 20 minutes, at 180° C. for 30 minutes, at 240° C. for 20 hours and at 260° C. for 5 hours.

The resin composition layer/copper foil composite film thus obtained was first immersed in a swelling solution containing “Swelling Dip Securiganth P” (manufactured by Atotech Japan) at 60° C. for 5 minutes, then in an alkaline permanganate solution at 80° C. for 20 minutes to conduct a roughening treatment of the surface of the resin composition layer, and manganese finally remaining on the surface was removed by reduction (surface roughness: 764 nm).

Subsequently, a catalyst for electroless copper plating was provided to the surface of the resin composition layer after the aforementioned roughening treatment, and the film was immersed in a electroless plating solution at 32° C. for 30 minutes to form a 1.5 μm-thick electroless copper plating film. This was dried at 150° C. for 30 minutes, washed with an acid, and subjected to electrolytic copper plating with a phosphorus-containing copper plate as an anode at anodic current density 2.0 A/dm² for 12 minutes to form a 5 μm-thick copper plating film. After annealing at 180° C. for 30 minutes, the adhesion strength (plating peel strength) between this plating film and a resin composition layer was measured and found to be 0.55 kgf/cm. The resulting film was further subjected to an annealing treatment at 150° C. for 100 hours, and the adhesion strength (plating peel strength) between the plating film and the resin composition layer was measured and found to be 0.55 kgf/cm.

### Example 2

Polyamideimide varnish “Vylomax HR11NN” (70 parts, solid content 15 w %, manufactured by Toyobo Co., Ltd.) was mixed with silica particles (2.5 parts, average particle size: 0.22 μm), and the mixture was dispersed in a rotating•revolving mixer (AwatoriRentaro AR250, manufactured by Thinky corporation) for 12 minutes to give a resin composition varnish (b).

Then, this resin composition varnish (b) was applied to a mat surface of a 18 μm-thick copper foil with a bar coater such that the resin thickness after drying became 30 μm, and stepwisely dried at 75-130° C. (average 110° C.) for about 20 minutes, at 180° C. for 30 minutes, at 240° C. for 20 hours and at 260° C. for 5 hours.

The resin composition layer/copper foil composite film thus obtained was first immersed in a swelling solution containing “Swelling Dip Securiganth P” (manufactured by Atotech Japan) at 60° C. for 5 minutes, then in an alkaline permanganate solution at 80° C. for 20 minutes to conduct a roughening treatment of the surface of the resin composition layer, and manganese finally remaining on the surface was removed by reduction (surface roughness: 864 nm).

Subsequently, a catalyst for electroless copper plating was provided to the surface of the resin composition layer after the aforementioned roughening treatment, and the film was immersed in a electroless plating solution at 32° C. for 30 minutes to form a 1.5 μm-thick electroless copper plating film. This was dried at 150° C. for 30 minutes, washed with an acid, and subjected to electrolytic copper plating with a phosphorus-containing copper plate as an anode at anodic current density 2.0 A/dm² for 12 minutes to form a 5 μm-thick copper plating film. After annealing at 180° C. for 30 minutes, the adhesion strength (plating peel strength) between this plating film and a resin composition layer was measured and found to be 0.6 kgf/cm. The resulting film was further subjected to an annealing treatment at 150° C. for 100 hours, and the adhesion strength (plating peel strength) between the plating film and the resin composition layer was measured and found to be 0.71 kgf/cm.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method of producing a metallized polyamideimide film, which comprises:
(a) treating an inorganic filler-containing polyamideimide film with an alkaline permanganate solution, to obtain a treated film; and
(b) subjecting said treated film to electroless copper plating, to form a electroless copper plating layer.

2. The method of claim 1, wherein said inorganic filler-containing polyamideimide film is obtained by drying by heating a resin composition varnish comprising a polyamideimide and inorganic filler.

3. The method of claim 2, wherein said resin composition varnish is applied onto a support, and said treatment with an alkaline permanganate solution and said electroless copper plating are successively performed.

4. The method of claim 3, wherein said support is a copper foil.

5. The method of claim 3, wherein said support is a polyimide film.

6. The method of claim 1, wherein said inorganic filler-containing polyamideimide film is subjected to a swelling treatment with an alkaline solution before said treatment with the alkaline permanganate solution.

7. The method of claim 1, which further comprises:
(c) conducting electrolytic copper plating after said electroless copper plating, to form an electrolytic copper plating layer.

8. The method of claim 1, wherein a catalyst is provided onto the surface of said inorganic filler-containing polyamideimide film before the electroless copper plating.

9. The method of claim 8, wherein said catalyst is palladium.

10. The method of claim 1, wherein said inorganic filler is one or more kinds selected from the group consisting of silica, silicon particles, calcium carbonate, and mixtures thereof.

11. The method of claim 1, wherein wherein said inorganic filler comprises silica.

12. The method of claim 1, wherein said inorganic filler has an average particle size of from 0.01 to 5 μm.

13. The method of claim 2, wherein said varnish comprises said inorganic filler in a proportion of 2 to 100 parts by weight per 100 parts by weight of said polyamideimide.

14. The method of claim 1, wherein said alkaline permanganate solution comprises at least one member selected from the group consisting of potassium permanganate, sodium permanganate, and mixtures thereof.

15. The method of claim 1, wherein said inorganic filler-containing polyamideimide film has a thickness of from 5 to 125 μm, and said electroless copper plating layer has a thickness of from 0.1 to 3 μm.

16. The method of claim 7, wherein said inorganic filler-containing polyamideimide film has a thickness of from 5 to 125 μm, said electroless copper plating layer has a thickness of from 0.1 to 3 μm, and the total thickness of said electroless copper plating layer and said electrolytic copper plating layer is from 3 to 35 μm.

17. The method of claim 4, wherein said copper foil support has a thickness of from 3 to 35 μm.

18. The method of claim 5, wherein said polyimide film support has a thickness of from 10 to 125 μm.

19. The method of claim 1, wherein an annealing treatment is conducted after said electroless copper plating or the electrolytic copper plating.

20. The method of claim 7, wherein an annealing treatment is conducted after said electrolytic copper plating.

21. The method of claim 1, wherein said inorganic filler-containing polyamideimide film further comprises one or more kinds of heat resistant resins selected from the group consisting of polyamide, polyimide, polyetheretherketone, polyetherimide, polybenzoxazole, polybenzoimidazole, and mixtures thereof in a proportion of not more than 30 parts by weight relative to 100 parts by weight of polyamideimide.

22. The method of claim 21, wherein said one or more kinds of heat resistant resins comprises a phenolic hydroxyl group in a molecular skeleton.

23. A metallized polyamideimide film comprising a polyamideimide film layer and a conductive layer formed on at least one surface of said polyamideimide film layer, wherein said polyamideimide film layer comprises an inorganic filler and has a roughening treated surface on which said conductive layer is formed.

24. The metallized polyamideimide film of claim 23, wherein said polyamideimide film layer comprising an inorganic filler is formed on a support.

25. The metallized polyamideimide film of claim 24, wherein said support is a copper foil layer.

26. The metallized polyamideimide film of claim 24, wherein said support is a polyimide film layer.

27. The metallized polyamideimide film of claim 23, wherein said inorganic filler is one or more kinds selected from the group consisting of silica, silicon particles, calcium carbonate, and mixtures thereof.

28. The metallized polyamideimide film of claim 23, wherein said inorganic filler comprises silica.

29. The metallized polyamideimide film of claim 23, wherein said inorganic filler has an average particle size of from 0.01 to 5 μm.

30. The metallized polyamideimide film of claim 23, wherein said polyamideimide film layer comprises said inorganic filler in an amount of 2 to 100 mass % relative to polyamideimide.

31. The metallized polyamideimide film of claim 23, wherein said polyamideimide film layer has a thickness of from 5 to 125 μm, and said conductive layer has a thickness of from 3 to 35 μm.

32. The metallized polyamideimide film of claim 25, which comprises a laminate of said copper foil layer/said polyamideimide film layer comprising an inorganic filler/said conductive layer laminated in this order, wherein said copper foil layer has a thickness of from 3 to 35 μm, said polyamideimide film layer has a thickness of from 5 to 125 μm, and said conductive layer has a thickness of from 3 to 35 μm.

33. The metallized polyamideimide film of claim 26, which comprises a laminate of said polyimide film layer/said polyamideimide film layer comprising an inorganic filler/said conductive layer laminated in this order, wherein said polyimide film layer has a thickness of from 10 to 125 μm, said polyamideimide film layer has a thickness of from 5 to 125 μm, and said conductive layer has a thickness of from 3 to 35 μm.

34. The metallized polyamideimide film of claim 23, wherein said roughening treated surface of the polyamideimide film layer has a surface roughness of from 100 to 1500 nm.

35. The metallized polyamideimide film of claim 23, wherein said conductive layer is a copper plating layer.

36. The metallized polyamideimide film of claim 23, wherein said roughening treatment of the roughening treated surface of said polyamideimide film layer is obtained by a treatment with an alkaline permanganate solution.

37. The metallized polyamideimide film of claim 36, wherein said alkaline permanganate solution comprises at least one member selected from the group consisting of potassium permanganate, sodium permanganate, and mixtures thereof.

38. The metallized polyamideimide film of claim 23, wherein said polyamideimide film comprising an inorganic filler further comprises one or more kinds of heat resistant resins selected from the group consisting of polyamide, polyimide, polyetheretherketone, polyetherimide, polybenzoxazole, polybenzoimidazole, and mixtures thereof in a proportion of not more than 30 parts by weight relative to 100 parts by weight of polyamideimide.

39. The metallized polyamideimide film of claim 38, wherein said heat resistant resin comprises a phenolic hydroxyl group in a molecular skeleton.
